(19) United States
(12) Patent Application Publication
(10) Pub. No.: US 2026/0360784 A1
(43) Pub. Date: Nov. 12, 2026

(54) MEMBRANE ELECTRODE ASSEMBLY WITH PROTECTED EDGE AND METHOD

(71) Applicant: GM Global Technology Operations LLC, Detroit, MI (US)

(72) Inventors: Swaminatha P. Kumaraguru, Rochester Hills, MI (US); Thomas D. Bronchetti, Auburn Hills, MI (US)

(21) Appl. No.: 19/199,800

(22) Filed: May 6, 2025

(51) Int. Cl. H01M 8/1004; H01M 4/88; H01M 8/0258

(52) U.S. Cl. CPC H01M 8/1004; H01M 4/8807; H01M 4/8825; H01M 8/0258

(57) ABSTRACT

According to several aspects of the present disclosure, a membrane electrode assembly and methods are provided. The membrane electrode assembly includes an anode gas diffusion layer, an anode electrode disposed on the anode gas diffusion layer, a cathode gas diffusion layer, a cathode electrode disposed on the cathode gas diffusion layer, and a membrane. The anode electrode includes an anode channel extending around and near an anode periphery of the anode electrode. The cathode electrode includes a cathode channel extending around and near a cathode periphery of the cathode electrode such that the cathode channel forms electrode discontinuity from a cathode edge.

### INTRODUCTION

The present disclosure relates to membrane electrode layer assemblies for fuel cells, and more particularly to a membrane electrode assembly using a standalone membrane with recessed dimensions near edges.

Electrochemical fuel cells are used as electrical power sources for electric vehicles or other devices. Electrochemical fuel cells, or simply fuel cells, convert reactants in the form of fuel and oxidants into electricity. In one exemplary configuration, a fuel cell includes an anode layer, a cathode layer spaced from the anode layer, and a polymer electrolyte membrane (PEM) separating the anode layer and cathode layer. A hydrogen-rich gas or pure hydrogen is supplied as fuel to the anode layer side of the fuel cell while oxygen is supplied to the cathode layer side. The anode layer and cathode layer form an electric circuit when a current flowing from the anode layer to the cathode layer is routed through a connected external load. The PEM prevents gas crossover and electric current flow but permits proton migration from the anode layer to the cathode layer.

While present fuel cells achieve their intended purpose, there is need for improvement in the high volume roll to roll process for membrane electrode assembly manufacturing and to address failure modes that are prevalent.

### SUMMARY

According to several aspects of the present disclosure, a membrane electrode assembly is provided. The membrane electrode assembly includes an anode gas diffusion layer, an anode electrode disposed on the anode gas diffusion layer, a cathode gas diffusion layer, a cathode electrode disposed on the cathode gas diffusion layer, and a membrane. The anode electrode has an anode surface area, and the anode electrode includes an anode channel extending around and near an anode periphery of the anode electrode such that the anode channel forms electrode discontinuity from an anode edge and forms a segmented anode electrode layer. The cathode electrode has a cathode surface area, and the cathode electrode includes a cathode channel extending around and near a cathode periphery of the cathode electrode such that the cathode channel forms electrode discontinuity from a cathode edge. The anode electrode is disposed on the membrane and the cathode electrode is disposed on the membrane opposite the anode electrode. The membrane has a first membrane surface area facing the anode electrode and a second membrane surface area facing the cathode electrode. The first membrane surface area is smaller than the anode surface area, and the second membrane surface area is smaller than the cathode surface area.

In accordance with another aspect of the disclosure, the membrane electrode assembly further includes a subgasket disposed between the cathode electrode layer and the segmented anode electrode layer.

In accordance with another aspect of the disclosure, the subgasket includes an inner window that defines an active area of the membrane electrode assembly.

In accordance with another aspect of the disclosure, the inner window has a surface area smaller than a membrane surface area, the cathode surface area, and the anode surface area.

In accordance with another aspect of the disclosure, the inner window has a surface area smaller than a membrane surface area and an anode surface area, and the inner window has a surface area equal to a surface area of the cathode electrode.

According to several aspects of the present disclosure, a method for forming a membrane electrode assembly is provided. The method includes roll-to-roll coating a cathode gas diffusion layer with a cathode electrode to form a cathode electrode layer, and roll-to-roll coating an anode gas diffusion layer with an anode electrode to form an anode electrode layer. The method also includes laser ablating the cathode electrode in a cross-machine direction to remove a portion of the cathode electrode to form a segmented cathode electrode and laser ablating the anode electrode in a cross-machine direction to remove a portion of the anode electrode to form a segmented anode electrode. The segmented cathode electrode is electrode-free on a cathode periphery of the edges of the segmented cathode electrode. The segmented anode electrode is electrode-free on an anode periphery of the edges of the segmented anode electrode. The method also includes laminating a membrane to the cathode electrode, placing a subgasket between the membrane and the segmented anode electrode, and laminating the segmented cathode electrode, the segmented anode electrode, the membrane, and the subgasket to form a unitized membrane electrode assembly. The membrane has a smaller membrane surface area than a cathode gas diffusion layer surface area and a smaller membrane surface area than an anode gas diffusion layer surface area.

In accordance with another aspect of the disclosure, laminating the membrane to the cathode electrode includes a roll-to-roll process.

In accordance with another aspect of the disclosure, laminating the membrane to the cathode electrode includes discrete steps.

In accordance with another aspect of the disclosure, a membrane surface area is the same as a cathode surface area.

In accordance with another aspect of the disclosure, a membrane surface area is larger than a cathode surface area.

In accordance with another aspect of the disclosure, the subgasket includes an inner window that defines an active area of the membrane electrode assembly.

In accordance with another aspect of the disclosure, the inner window has a surface area smaller than a membrane surface area, a cathode surface area, and an anode surface area.

In accordance with another aspect of the disclosure, the inner window has a surface area smaller than a membrane surface area and an anode surface area, and wherein the inner window has a surface area equal to a surface area of the cathode electrode.

In accordance with another aspect of the disclosure, the membrane electrode assembly is a fuel cell membrane electrode assembly.

According to several aspects of the present disclosure, a method for forming a membrane electrode assembly is provided. The method includes roll-to-roll coating a cathode gas diffusion layer with a continuous cathode electrode and roll-to-roll coating an anode gas diffusion layer with a continuous anode electrode. The method includes removing a portion of the continuous cathode electrode to form a cathode channel, where the cathode channel extends around a cathode periphery, and removing a portion of the continuous anode electrode to form an anode channel, where the anode channel extends around an anode periphery. The method includes segmenting the cathode gas diffusion layer and the cathode electrode to form a segmented cathode electrode and segmenting the anode gas diffusion layer and the anode electrode to form a segmented anode electrode. The method includes laminating a membrane to the cathode electrode, placing a subgasket between the membrane and the segmented anode electrode, and laminating the segmented cathode electrode, the segmented anode electrode, the membrane, and the subgasket to form a unitized membrane electrode assembly. The membrane has a smaller surface area than a segmented cathode electrode and a smaller surface area than a segmented anode electrode.

In accordance with another aspect of the disclosure, laminating the membrane to the cathode electrode includes a roll-to-roll process.

In accordance with another aspect of the disclosure, laminating the membrane to the cathode electrode includes discrete steps.

In accordance with another aspect of the disclosure, the subgasket includes an inner window that defines an active area of the membrane electrode assembly.

In accordance with another aspect of the disclosure, a laser ablation process is used to form the channels around the periphery of anode electrode layer and cathode electrode layer.

In accordance with another aspect of the disclosure, the inner window has a surface area smaller than a membrane surface area, a cathode surface area, and an anode surface area.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a top perspective view illustrating an example of a vehicle having an electric motor powered by a fuel cell, in accordance with the present disclosure.

FIG. 2 is a diagrammatic representation illustrating a cross-section of a membrane electrode assembly (MEA) configurable for use in an electrochemical cell and fuel cell, for example in the vehicle shown in FIG. 1, wherein an anode electrode, a membrane, and a cathode electrode have a smaller surface area than a cathode or anode gas diffusion layer, in accordance with the present disclosure.

FIG. 3 is a diagrammatic representation illustrating a cross-section of a membrane electrode assembly (MEA) configurable for use in an electrochemical cell and fuel cell, for example in the vehicle shown in FIG. 1, wherein an anode electrode, a membrane, and a cathode electrode have a smaller surface area than a cathode or anode gas diffusion layer, and where in the cathode electrode has a smaller surface area than the anode electrode or the membrane, in accordance with the present disclosure.

FIG. 4 is a diagrammatic representation illustrating a cross-section of a membrane electrode assembly (MEA) configurable for use in an electrochemical cell and fuel cell, for example in the vehicle shown in FIG. 1, wherein the anode electrode has an anode channel, and the cathode electrode has a cathode channel, in accordance with the present disclosure.

FIG. 5 is a flowchart illustrating a method for forming the membrane electrode assembly shown in FIGS. 2 and 3, in accordance with the present disclosure.

FIG. 6 is a flowchart illustrating a method for forming the membrane electrode assembly shown in FIG. 4, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

Proton exchange membrane fuel cells rely on membrane electrode assemblies (MEAs) for efficient electrochemical reactions. High-volume roll-to-roll manufacturing of MEAs using a gas diffusion electrode (GDE) approach has significantly reduced production costs, making fuel cells more commercially viable. However, due to the continuous roll to roll coating aspect of current GDE MEA designs, the gas diffusion layer (GDL), electrode, and membrane include identical dimensions in both plan and lateral views. This prevalent edge configuration makes the MEAs susceptible to contamination from other cell components such as during bipolar plate assembly. The membrane electrode assemblies are arranged between bipolar plates that are made of metal such as stainless steel. Corrosion of the bipolar plates can cause metal ions (such as iron (Fe²⁺) to be released. While the hydrophobic gas diffusion layer repels water and thereby limits Fe²⁺ pathway into the MEA, the exposed membrane at the edge offers a pathway for Fe²⁺ to enter the MEA. Fe²⁺, a known Fenton's reagent, accelerates undesired reactions, such as decomposing hydrogen peroxide to hydroxide (OH) radicals, leading to rapid degradation of the membrane and thereby limiting life. While OH radical scavengers, like Ce³⁺ and/or Mn²⁺, added in the membrane provide some mitigation, arrival of Fe²⁺ into the MEA leads to membrane failure. In addition to the membrane, an exposed electrode edge containing an ion conducting ionomer as a binder can also form a conduit to metal cation contaminants. In certain designs, where the subgasket is present between the anode electrode and the membrane, resulting in a cathode larger than the anode electrode, the radical scavenger cations (Ce³⁺ and Mn²⁺) driven by potential gradients tend to build up under the subgasket or other metal (M⁺) to build up at outer edges of the GDLs, the anode electrode layer, the cathode electrode layer, and the membrane layer causing additional performance or durability issues.

To address these challenges, an improved unitized electrode assembly (UEA) design is desired, in which the membrane and electrode are recessed relative to the GDL, reducing edge exposure and enhancing durability. The oversized GDL encapsulates the membrane and electrode in the periphery. This approach minimizes the risk of Fe²⁺ and other metal cation contamination while maintaining high manufacturing throughput. The present disclosure provides a novel method for fabricating an MEA with a standalone membrane that features recessed dimensions near the edges, enabling better protection against external contaminants without compromising the efficiency and scalability of roll-to-roll manufacturing. A membrane electrode assembly and methods for forming the membrane electrode assembly are disclosed herein.

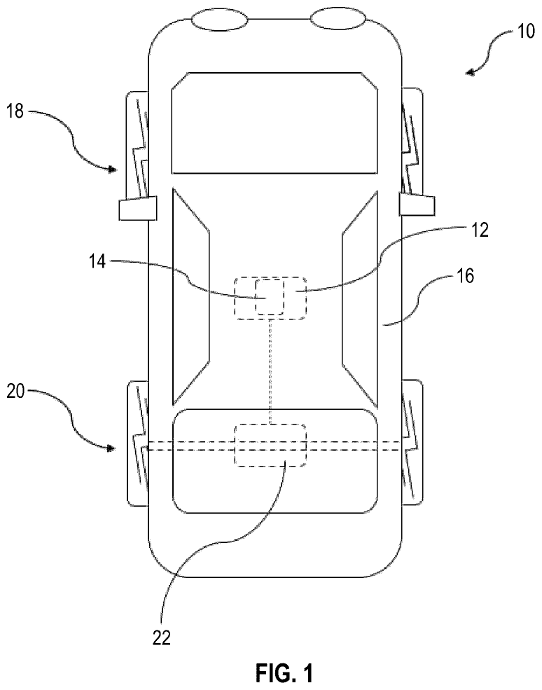

Referring to FIG. 1, a schematic view of a vehicle 10 having an energy conversion device 12 is illustrated, in accordance with the present disclosure. The vehicle 10 generally includes a body 16, which has front wheels 18 and rear wheels 20. The front wheels 18 and the rear wheels 20 are each rotationally located near a respective corner of the body 16. At least one of the front wheels 18 and the rear wheels 20 is propelled by a motor 22 powered directly or indirectly by the energy conversion device 12. In some embodiments, vehicle 10 receives hydrogen fuel from an external electrolyzer 14 (electrolysis cells) configured to produce hydrogen that can be delivered to the energy conversion device 12.

In one non-limiting embodiment, the motor 22 is an electric motor, and the energy conversion device 12 is a fuel cell configured to convert a hydrogen rich fuel and oxygen from the ambient air into electricity to power the electric motor. While the vehicle 10 is depicted in the illustrated embodiment as a passenger car, other examples of vehicles include, but are not limited to, motorcycles, trucks, sport utility vehicles (SUVs), recreational vehicles (RVs), marine vessels, and aircraft. In certain embodiments, the energy conversion device 12 is a unitized regenerative fuel cell.

As used herein, the term “vehicle” is not limited to automobiles. While the present technology is described primarily herein in connection with electric and/or hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines. These fuel cells can be used to power stationary applications as well.

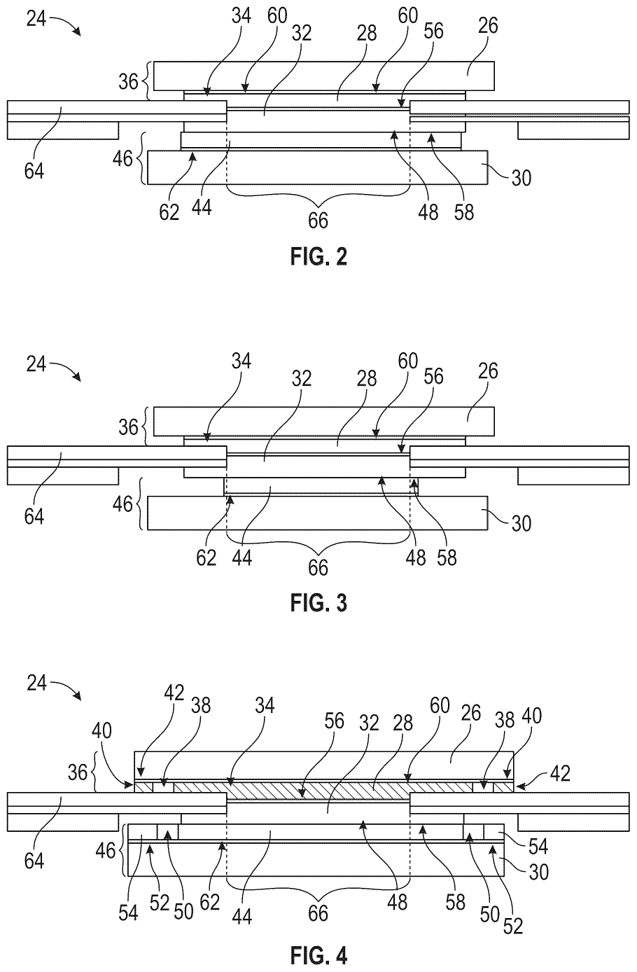

FIGS. 2 through 4 are diagrammatic illustrations of non-limiting examples of a membrane electrode assembly (MEA) 24 disposed in the energy conversion device 12. The energy conversion device 12 may include a fuel cell. The fuel cell generates electricity through a chemical reaction between hydrogen and oxygen. Hydrogen gas can be supplied to the anode side of the fuel cell, where it is split into protons and electrons. The protons pass through the electrolyte to the cathode, while the electrons travel through an external circuit, creating an electric current. On the cathode side, oxygen gas is introduced, and it combines with the protons and electrons to form water and heat. The membrane electrode assembly (MEA) 24 includes an anode gas diffusion layer 26, an anode electrode layer 28, a cathode gas diffusion layer 30, and a membrane 32. In an example, the membrane electrode assembly 24 is a fuel cell membrane electrode assembly. In another example, the membrane electrode assembly 24 is an electrolysis cell membrane electrode assembly.

The anode gas diffusion layer 26 is configured to provide pathways for reactant gases (e.g., hydrogen and oxygen) to reach a catalyst layer, facilitate removal of water produced during the reaction, and help manage heat and water transport within the fuel cell. The anode gas diffusion layer 26 facilitates transport of hydrogen gas to the catalyst layer, where it is split into protons and electrons. The anode gas diffusion layer (GDL) 26 may be formed of porous carbon paper made of non-woven carbon fibers. Often coated with hydrophobic materials, it enhances water management by being hydrophobic. In certain PEM systems, flat sheets of titanium, stainless steel, nickel may also be used as a gas diffusion layer.

The anode electrode layer 28 is disposed on and adjacent to the anode gas diffusion layer 26 and has an anode surface area 34. The anode electrode layer 28 and the anode gas diffusion layer 26 form an anode electrode 36. In a fuel cell, the anode electrode layer 28 is where the oxidation reaction occurs. In a typical hydrogen fuel cell, hydrogen gas is supplied to the anode where a catalyst (e.g., platinum) facilitates splitting of hydrogen molecules into protons and electrons. The protons pass through the MEA 24 while the electrons travel through an external circuit, generating an electric current. In an example, the anode electrode layer 28 is narrower in width than the anode gas diffusion layer 26.

In some instances, the anode electrode layer 28 includes an anode channel 38. The anode channel 38 can extend around and near an anode periphery 40 of the anode electrode layer 28 such that the anode channel 38 forms electrode discontinuity from an anode edge 42 and forms a segmented anode electrode 36. The anode channel 38 and discontinuous anode edge 42 serves to prevent iron (Fe²⁺) and metal ion (M⁺) intrusion into the MEA 24 and specifically to the membrane 32. Fe²⁺ is primarily formed due to the corrosion of the bipolar plate assembly that is typically made of stainless steel. The Fe2+ could also be carried in the fuel cell stack corrosion of non-cell or non-stack components but still in fluid connection with the stack and cells.

The cathode gas diffusion layer 30 is configured to provide pathways for reactant gases to reach a catalyst layer, facilitate removal of water produced during the reaction, and help manage heat and water transport within the fuel cell. The cathode gas diffusion layer 30 facilitates transport of oxygen gas to the catalyst layer. The cathode gas diffusion layer 30 may be formed of porous carbon paper made of non-woven carbon fibers. Often coated with hydrophobic materials, it enhances water management by being hydrophobic. In certain PEM systems, flat sheets of titanium, stainless steel, nickel may also be used as gas diffusion layer.

The cathode electrode layer 44 is disposed on and adjacent to the cathode gas diffusion layer 30. The cathode electrode layer 44 and the cathode gas diffusion layer 30 form a cathode electrode 46. The cathode electrode layer 44 has a cathode surface area 48. At the cathode electrode layer 44, a reduction reaction occurs combining oxygen with protons and electrons to form water and produce electricity. The cathode electrode layer 44 may include a catalyst layer, often made from platinum or platinum-based alloys supported on a carbon substrate and an ion conducting polymer to facilitate protons to the catalyst nanoparticles. In an example, the cathode electrode layer 44 is narrower in width than the cathode gas diffusion layer 30.

In some instances, the cathode electrode layer 44 includes a cathode channel 50. The cathode channel 50 extends around and near a cathode periphery 52 of the cathode electrode layer 44 such that the cathode channel 50 forms electrode discontinuity from a cathode edge 54. The cathode channel 50 and discontinuous cathode edge 54 serves to prevent iron (Fe²⁺) and metal ion (M⁺) intrusion into the MEA 24 and specifically to the membrane 32.

The membrane 32 (e.g., a polymer electrolyte membrane (PEM)) conducts positively charged ions (i.e., protons) while blocking electrons. The membrane 32 has selective permeability and allows protons generated at the anode electrode layer 28 to pass through to the cathode electrode layer 44, where the protons react with oxygen to form water. The membrane 32 also electrically insulates the anode electrode layer 28 from the cathode electrode layer 44. The proton conducting membrane is also a strong conduit for metal cations. Hence membrane layers are recessed to prevent contaminants like Fe²⁺ entering the MEA through exposed edges.

In the example shown in FIG. 2, the anode electrode layer 28 is disposed on a first membrane surface area 56 of the membrane 32 facing the anode electrode layer 28, and the cathode electrode layer 44 is disposed on a second membrane surface area 58 of the membrane 32 facing the cathode electrode layer 44 and opposite the anode electrode layer 28. In an example, the membrane 32 may be formed of an ion conducting polymer such as perflurosulfonic acid (PFSA) or a sulfonated hydrocarbon-based ionomer. In the example shown in FIG. 2, the anode surface area 34, the membrane 32, and the cathode surface area 48 are the same and are smaller than an anode gas diffusion layer surface area 60 and the cathode gas diffusion layer surface area 62. In another example, shown in FIG. 3, the second membrane surface area 58 is larger than the cathode surface area 48.

As shown in FIGS. 2 through 4, the membrane electrode assembly 24 may include a subgasket 64 disposed between the membrane 32 and the segmented anode electrode 36. The subgasket 64 helps ensure proper alignment and sealing of the MEA 24 and may include one or more layers. The subgasket 64 may be formed from an adhesive film or a polymeric material, for example polyethylene napthalate, polypropylene terephthalate, polyphenyl sulfide, polyimide etc. An adhesive layer on the polymeric film is layered against the membrane for sealing around the edges. The subgasket 64 may include an inner window 66 that defines an active area of the MEA 24, for example an area between the membrane 32 and the anode electrode layer 28. In an example, the inner window 66 has a surface area smaller than the first membrane surface area 56, the second membrane surface area 58, the cathode surface area 48, and the anode surface area 34.

FIGS. 2 through 4 illustrate the membrane electrode assembly 24 having a cathode gas diffusion layer 30, a cathode electrode layer 44 disposed on the cathode gas diffusion layer 30, a membrane 32 disposed on the cathode electrode layer 44, and an anode electrode layer 28 disposed on the membrane 32 with a subgasket 64 disposed between the membrane 32 and the anode electrode layer 28. The membrane electrode assembly 24 also includes an anode gas diffusion layer 26 disposed on the anode electrode layer 28. In the example shown in FIG. 3, the cathode surface area 48 of the cathode electrode layer 44 is smaller than a second membrane surface area 58 of the membrane 32. In certain examples, the cathode surface area 48 is nearly of identical dimension as sub gasket window area 66. This arrangement helps to prevent iron ion (Fe²⁺) intrusion into the cell as well as to prevent metal ion (M⁺) or radical scavenger (Ce³⁺, Mn=) accumulation under subgasket edges of the membrane electrode assembly 24 and to maintain protection offered by radical scavengers.

FIG. 4 illustrates the membrane electrode assembly 24 having a cathode gas diffusion layer 30, a cathode electrode layer 44 disposed on the cathode gas diffusion layer 30, a membrane 32 disposed on the cathode electrode layer 44, and an anode electrode layer 28 disposed on the membrane 32 with a subgasket 64 disposed between the membrane 32 and the anode electrode layer 28. The membrane electrode assembly 24 also includes an anode gas diffusion layer 26 disposed on the anode electrode layer 28. In this example, the cathode electrode layer 44 includes the cathode channel 50, and the anode electrode layer 28 includes the anode channel 38. The cathode channel 50 and the anode channel 38 help to prevent iron ion (Fe²⁺) or metal ion (M⁺) intrusion and M⁺ accumulation under edges of the membrane electrode assembly 24 and assists in preventing corrosion. A length and width of a surface of the membrane 32 is smaller than a length or width the cathode channel 50 such that the membrane 32 does not extend to the cathode channel 50.

Though explicitly not shown in FIGS. 2-4, the gas diffusion layer 30 and 26 are significantly thicker (5X-15X) than the rest of the membrane electrode assembly layers including the anode electrode layer, 28, the cathode electrode layer 44, and the membrane 32. The GDLs 26 and 30 are also compressible materials (for example, a Sigracet™ 39BB GDL has an uncompressed thickness of about ~300 um vs. a compressed thickness of ~220 um @ 1 MPA). As a result, the anode gas diffusion layer 26 and the cathode gas diffusion layer 30 protect edges of each recessed electrode and the membrane layers when the membrane electrode assembly 24 is compressed during a lamination step and during a stack build between bipolar plates. Because the anode gas diffusion layer 26 and the cathode gas diffusion layer 30 are hydrophobic, they tend to collect water near the edges and contaminants along with it. The subgasket 64 is located between the membrane 32 and anode electrode layer 26. Further, the adhesive in the subgasket facing the membrane bonds with the membrane 32 and uncoated gas diffusion layer edge forming a protected edge. In examples where a cathode channel 50 or an anode channel 38 is formed on the periphery, the adhesive could flow in those channels and enable complete discontinuity of either electrode from the edge. As can be appreciated, in certain examples, the subgasket layer 64 can be located between the membrane 32 and cathode electrode layer 44.

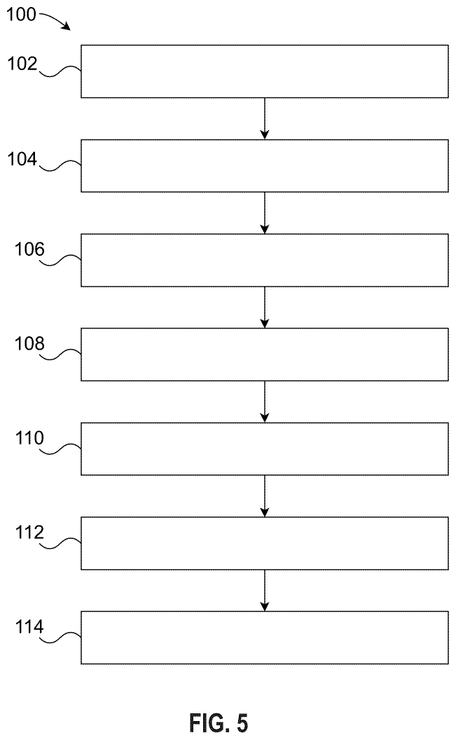

With reference to FIG. 5, a method 100 for forming the membrane electrode assembly 24 as shown in FIGS. 2 and 3 is presented, in accordance with the present disclosure. The method 100 starts at block 102.

Block 102 depicts roll-to-roll coating the cathode gas diffusion layer 30 with a cathode electrode layer 44 to form the cathode electrode 46. Roll-to-roll (R2R) processing is continuous and includes unwinding a large roll of the cathode gas diffusion layer 30 and applying, for example, an ink including a catalyst mixed with a binder and solvent. The ink may then be dried to remove the solvent and create the cathode electrode layer 44. The cathode gas diffusion layer 30 and the cathode electrode layer 44 together form the cathode electrode 46.

Block 104 depicts roll-to-roll coating the anode gas diffusion layer 26 with the anode electrode layer 28 to form the anode electrode 36. The roll-to-roll coating may include continuously unwinding a roll of the anode gas diffusion layer 26 and applying, for example, an ink including a catalyst mixed with a binder and solvent. The ink may then be dried to remove the solvent and create the anode electrode layer 28. The anode gas diffusion layer 26 and the anode electrode layer 28 together form the anode electrode 36.

Block 106 depicts laser ablating the cathode electrode 46 in a cross-machine direction to remove a portion of the cathode electrode to form a segmented cathode electrode 46. Laser ablating the cathode electrode 46 can include using a laser to remove a portion of the cathode electrode layer 44. The cross-machine direction can include a direction perpendicular to a direction of unwinding the roll of cathode gas diffusion layer 30. The removed portion may extend around a cathode periphery 52, where the cathode surface area 48 is smaller than the cathode gas diffusion layer surface area 62.

Block 108 depicts laser ablating the anode electrode 36 in a cross-machine direction to remove a portion of the anode electrode layer 28 to form a segmented anode electrode 36. Laser ablating the anode electrode 36 can include using a laser to remove a portion of the anode electrode layer 28. The cross-machine direction can include a direction perpendicular to a direction of unwinding the roll of anode gas diffusion layer 26. The removed portion may extend around an anode periphery 40, where the anode surface area 34 is smaller than the anode gas diffusion layer surface area 60.

Block 110 depicts laminating the membrane 32 to the cathode electrode layer 44. Laminating the membrane 32 may include using a laminator or hot press to subject the membrane 32 and cathode electrode 46 to heat and pressure, which bonds the membrane 32 to the cathode electrode layer 44. For example, laminating the membrane 32 may include a temperature in the range of 120-200 °C and a pressure in the range of 1-5 megapascals (MPa). Laminating the membrane 32 may include a roll-to-roll process or discrete steps.

Block 112 depicts placing the subgasket 64 between the membrane 32 and the segmented anode electrode 36. Placing the subgasket 64 may include using an alignment tool and/or a robot to place and/or align the subgasket 64 between the membrane 32 and the segmented anode electrode 36.

Block 114 depicts laminating the segmented cathode electrode 46, the segmented anode electrode 36, the membrane 32, and the subgasket 64 to form a unitized membrane electrode assembly 24. Laminating the segmented cathode electrode 46, the segmented anode electrode 36, the membrane 32, and the subgasket 64 may include using a laminator or hot press to subject the segmented cathode electrode 46, the segmented anode electrode 36, the membrane 32, and the subgasket 64 to heat and pressure. In an example, laminating the membrane 32 may include a temperature in the range of 120-150 °C and a pressure in the range of 1-5 megapascals (MPa).

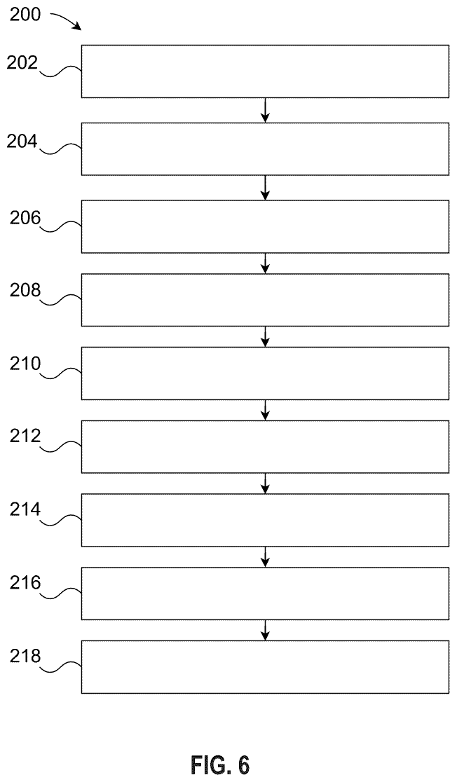

With reference to FIG. 6, a method 200 for forming the membrane electrode assembly as shown in FIG. 4 is presented, in accordance with the present disclosure. The method 200 starts at block 202.

Block 202 depicts roll-to-roll coating the cathode gas diffusion layer 30 with a continuous cathode electrode layer 44. Roll-to-roll coating the cathode gas diffusion layer 30 may include unwinding a large roll of the cathode gas diffusion layer 30 and applying, for example, an ink including a catalyst mixed with a binder and solvent. The ink may then be dried to remove the solvent and create the cathode electrode layer 44. The cathode gas diffusion layer 30 and the cathode electrode layer 44 together form the cathode electrode 46.

Block 204 depicts roll-to-roll coating the anode gas diffusion layer 26 with a continuous anode electrode layer 28. Roll-to-roll coating may include continuously unwinding a roll of the anode gas diffusion layer 26 and applying, for example, an ink including a catalyst mixed with a binder and solvent. The ink may then be dried to remove the solvent and create the anode electrode layer 28. The anode gas diffusion layer 26 and the anode electrode layer 28 together form the anode electrode 36.

Block 206 depicts removing a portion of the continuous cathode electrode layer 44 to form a cathode channel 50, where the cathode channel 50 extends around the cathode periphery 52. Removing the portion of the continuous cathode electrode layer 44 may include using a laser and laser ablation. It will be appreciated that removing the portion of the continuous cathode electrode layer 44 may include using other suitable processes.

Block 208 depicts removing a portion of the continuous anode electrode layer 28 to form an anode channel 38, where the anode channel 38 extends around an anode periphery 40. Removing the portion of the continuous anode electrode layer 28 may include using a laser and laser ablation. It will be appreciated that removing the portion of the continuous anode electrode layer 28 may include using other suitable processes.

Block 210 depicts segmenting the cathode gas diffusion layer 30 and the cathode electrode layer 44 to form a segmented cathode electrode 46. Segmenting may include using a slitting machine, a notching machine, a press machine with blades, and/or a laser machine to separate and segment the cathode gas diffusion layer 30 and the cathode electrode layer 44.

Block 212 depicts segmenting the anode gas diffusion layer 26 and the anode electrode layer 28 to form a segmented anode electrode 36. Segmenting may include using a slitting machine, a notching machine, a press machine with blades, and/or a laser machine to separate and segment the anode gas diffusion layer 26 and the anode electrode layer 28.

Block 214 depicts laminating the membrane 32 to the cathode electrode layer 44. Laminating the membrane 32 may include using a laminator or hot press to subject the membrane 32 to the cathode electrode layer 44. In an example, laminating the membrane 32 may include a temperature in the range of 120-150 °C and a pressure in the range of 1-5 megapascals (MPa). The membrane 32 has a smaller surface area than a segmented cathode electrode layer 44 and a smaller surface area than a segmented anode electrode layer 28.

Block 216 depicts placing a subgasket 64 between the membrane 32 and the segmented anode electrode 36. Placing the subgasket 64 may include using an alignment tool and/or a robot to place and/or align the subgasket 64 between the membrane 32 and the segmented anode electrode layer 28.

Block 218 depicts laminating the segmented cathode electrode 46, the segmented anode electrode 36, the membrane 32, and the subgasket 64 to form a unitized membrane electrode assembly 24. Laminating the segmented cathode electrode 46, the segmented anode electrode 36, the membrane 32, and the subgasket 64 may include using a laminator or hot press to subject the segmented cathode electrode 46, the segmented anode electrode 36, the membrane 32, and the subgasket 64 to heat and pressure. In an example, the laminating step may be performed at a temperature in the range of 120-150 °C and a pressure in the range of 1-5 megapascals (MPa).

The membrane electrode assembly and methods of the present disclosure are advantageous and beneficial over prior art. For example, the membrane 32, the anode electrode layer 28, and the cathode electrode layer 44 are recessed relative to the gas diffusion layer, reducing edge exposure and enhancing durability. This approach minimizes the risk of contamination from external Fe²⁺ cations during operation while maintaining high manufacturing throughput.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A membrane electrode assembly, comprising:
an anode gas diffusion layer;
an anode electrode disposed on the anode gas diffusion layer, wherein the anode electrode has an anode surface area, and wherein the anode electrode includes an anode channel extending around and near an anode periphery of the anode electrode such that the anode channel forms electrode discontinuity from an anode edge and forms a segmented anode electrode layer;
a cathode gas diffusion layer;
a cathode electrode disposed on the cathode gas diffusion layer, wherein the cathode electrode has a cathode surface area, and wherein the cathode electrode includes a cathode channel extending around and near a cathode periphery of the cathode electrode such that the cathode channel forms electrode discontinuity from a cathode edge; and
a membrane, wherein the anode electrode is disposed on the membrane and the cathode electrode is disposed on the membrane opposite the anode electrode, wherein the membrane has a first membrane surface area facing the anode electrode and a second membrane surface area facing the cathode electrode, wherein the first membrane surface area is smaller than the anode surface area, and wherein the second membrane surface area is smaller than the cathode surface area.

2. The membrane electrode assembly of claim 1, further comprising:
a subgasket disposed between the cathode electrode layer and the segmented anode electrode layer.

3. The membrane electrode assembly of claim 2, wherein the subgasket includes an inner window that defines an active area of the membrane electrode assembly.

4. The membrane electrode assembly of claim 3, wherein the inner window has a surface area smaller than a membrane surface area, the cathode surface area, and the anode surface area.

5. The membrane electrode assembly of claim 3, wherein the inner window has a surface area smaller than a membrane surface area and an anode surface area, and wherein the inner window has a surface area equal to a surface area of the cathode electrode.

6. A method for forming a membrane electrode assembly, comprising:
roll-to-roll coating a cathode gas diffusion layer with a cathode electrode to form a cathode electrode layer;
roll-to-roll coating an anode gas diffusion layer with an anode electrode to form an anode electrode layer;
laser ablating the cathode electrode in a cross-machine direction to remove a portion of the cathode electrode to form a segmented cathode electrode, wherein the segmented cathode electrode is electrode-free on a cathode periphery of the edges of the segmented cathode electrode;
laser ablating the anode electrode in a cross-machine direction to remove a portion of the anode electrode to form a segmented anode electrode, wherein the segmented anode electrode is electrode-free on an anode periphery of the edges of the segmented anode electrode;
laminating a membrane to the cathode electrode, wherein the membrane has a smaller membrane surface area than a cathode gas diffusion layer surface area and a smaller membrane surface area than an anode gas diffusion layer surface area;
placing a subgasket between the membrane and the segmented anode electrode; and
laminating the segmented cathode electrode, the segmented anode electrode, the membrane, and the subgasket to form a unitized membrane electrode assembly.

7. The method of claim 6, wherein laminating the membrane to the cathode electrode includes a roll-to-roll process.

8. The method of claim 6, where laminating the membrane to the cathode electrode includes discrete steps.

9. The method of claim 6, wherein a membrane surface area is the same as a cathode surface area.

10. The method of claim 6, wherein a membrane surface area is larger than a cathode surface area.

11. The method of claim 6, wherein the subgasket includes an inner window that defines an active area of the membrane electrode assembly.

12. The method of claim 11, wherein the inner window has a surface area smaller than a membrane surface area, a cathode surface area, and an anode surface area.

13. The method of claim 11, wherein the inner window has a surface area smaller than a membrane surface area and an anode surface area, and wherein the inner window has a surface area equal to a surface area of the cathode electrode.

14. The method of claim 6, wherein the membrane electrode assembly is a fuel cell membrane electrode assembly.

15. A method for forming a membrane electrode assembly, comprising:
roll-to-roll coating a cathode gas diffusion layer with a continuous cathode electrode;
roll-to-roll coating an anode gas diffusion layer with a continuous anode electrode;
removing a portion of the continuous cathode electrode to form a cathode channel, where the cathode channel extends around a cathode periphery;
removing a portion of the continuous anode electrode to form an anode channel, where the anode channel extends around an anode periphery;
segmenting the cathode gas diffusion layer and the cathode electrode to form a segmented cathode electrode;
segmenting the anode gas diffusion layer and the anode electrode to form a segmented anode electrode;
laminating a membrane to the cathode electrode, wherein the membrane has a smaller surface area than a segmented cathode electrode and a smaller surface area than a segmented anode electrode;
placing a subgasket between the membrane and the segmented anode electrode; and
laminating the segmented cathode electrode, the segmented anode electrode, the membrane, and the subgasket to form a unitized membrane electrode assembly.

16. The method of claim 15, wherein laminating the membrane to the cathode electrode includes a roll-to-roll process.

17. The method of claim 15, where laminating the membrane to the cathode electrode includes discrete steps.

18. The method of claim 15, wherein the subgasket includes an inner window that defines an active area of the membrane electrode assembly.

19. The method of claim 15, wherein a laser ablation process is used to form the channels around the periphery of anode electrode layer and cathode electrode layer.

20. The method of claim 15, wherein the inner window has a surface area smaller than a membrane surface area, a cathode surface area, and an anode surface area.
